(19) United States
(12) Patent Application Publication
(10) Pub. No.: US 2014/0248076 A1
(43) Pub. Date: Sep. 4, 2014

(54) SLIP DOWEL SYSTEM

(71) Applicant: SHAW & SONS, INC., Costa Mesa, CA (US)

(72) Inventor: RONALD D. SHAW, CORONA DEL MAR, CA (US)

(73) Assignee: SHAW & SONS, INC., COSTA MESA, CA (US)

(21) Appl. No.: 13/782,947

(22) Filed: Mar. 1, 2013

(51) Int. Cl. F16B 9/00

(52) U.S. Cl. CPC F16B 9/00
USPC 403/194

(57) ABSTRACT

Provided is an improved concrete dowel placement apparatus having a base member including a base plate that is disposable on the outer surface of the concrete form, and an extension member that extends through an aperture located within the concrete form. In this regard, the base member is supported by the concrete form, and is therefore generally configured to withstand higher loads than the conventional prior art designs. Furthermore, the particular attachment configuration spaces the base plate from the concrete slab, which generally prevents the base member from becoming embedded within or adhered to the concrete. As such, removal of the form from the cured concrete tends to be much easier than removal of conventional prior art systems. In addition, the base member is less likely to crack or break during removal, which reduces the overall cost, as fewer base members may need to be replaced.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to the art of concrete construction, and more particularly to devices for facilitating the placement of slip dowel rods within adjacent concrete slabs.

2. Background

In the art of concrete construction, it is commonplace to form “cold joints” between two or more poured concrete slabs. Such cold joints frequently become uneven or buckled due to normal thermal expansion and contraction of the concrete and/or compaction of the underlying soil caused by inadequate substrate preparation prior to pouring of the concrete. As a means of preventing buckling or angular displacement of such cold joints, it is common practice to insert smooth steel dowel rods generally known as “slip dowels” within the edge portions of adjoining concrete slaps in such a manner that the concrete slabs may slide freely along one or more of the slip dowels, thereby permitting linear expansion and contraction of the slabs while at the same time maintaining the slabs in a common plane and thus preventing undesirable buckling or unevenness of the cold joint.

In order to function effectively, slip dowels must be accurately positioned parallel within the adjoining concrete slabs. The non-parallel positioning of the dowels may prevent the desired slippage of the dowels and may defeat the purpose of the “slip dowel” application. Additionally, the individual dowels must be placed within one or both of the slabs in such a manner as to permit continual slippage or movement of the dowels within the cured concrete slab(s).

In the prior art, two methods of installing smooth “slip dowels” have become popular. According to the first method, a first concrete pour is made within a pre-existing form. After the first pour has cured, an edge of the form (usually a wooden stud) is stripped away. A series of holes are then drilled parallel into the first pour along the exposed edge from which the form has been removed. The depth and diameter of the individual holes varies depending on the application and the relative size of the concrete slabs to be supported. As a general rule, however, such holes are at least 12 inches deep and typically have a diameter of approximately five-eighths of an inch.

After the parallel aligned series of holes has been drilled into the first pour, smooth dowel rods are advanced into each such hole such that one end of each dowel rod is positioned within the first pour and the remainder of each dowel rod extends into a neighboring area where a second slab of concrete is to be poured. Thereafter, concrete is poured into such neighboring area and is permitted to set with the parallel aligned dowels extending thereinto. After the second pour has set, the slip dowels will be held firmly within the second slab but will be permitted to slide longitudinally within the drilled holes of the first slab thereby accommodating longitudinal expansion and contraction of the two slabs while at the same time preventing buckling or angular movement therebetween.

Although the above-described “drilling method” of placing slip dowels is effective, it will be appreciated that such method is extremely labor intensive. Along these lines, it generally takes approximately ten minutes to drill a five-eighths inch diameter by twelve inch long hole into the first pour. Furthermore, the drilling equipment, bits, accessories, and associated set up time tends to be very expensive. Moreover, the laborers who drill the holes and place the slip dowels must be adequately trained to ensure that the dowels are arranged perpendicular to the joint.

Another prior art method of slip dowel installation is shown in FIGS. 1-3, and includes the use of a base member 10 and a tubular dowel receiving sheath 12 which is connectable to the base member 10. The base member 10 includes an attachment plate 14 and an axial extension member 16 extending from the attachment plate 14. The base member 10 is connected to the inner face 18 of the form 20, such that the extension member 16 extends from the form 20 into the area where the concrete 22 is to be poured. Before the concrete 22 is poured, the sheath 12 is slid over the extension member 16 to maintain the sheath 12 in proper position during pouring and curing of the concrete 22. FIG. 2 shows the sheath 12 completely advanced over the extension member 16 before the concrete 22 is poured, while FIG. 3 shows the sheath 12 on the extension member 16 after the concrete 22 is poured. After the concrete 22 cures, the form 20 is removed, along with the base member 10, while the sheath 12 remains embedded within the cured concrete slab 22.

Though the use of the prior art placement device shown in FIGS. 1-3 presents advantages over the previously described placement methods, these methods and devices also possess certain deficiencies which detract from their overall utility. In particular, the particular mounting configuration of the base member 10 to the concrete form 20 (i.e., the base member 10 nailed to the inner surface 18 of the concrete form 20) may be associated with several drawbacks. One drawback is that the nail securing the base member 10 to the concrete form 20 may not always provide enough rigidity, which may lead to the base member 10 bending or breaking, especially if the base member 10 is inadvertently stepped on or loaded with the weight of a rebar mat. Another drawback is that the mounting configuration of the base member 10 shown in FIGS. 1-3 may make it difficult to remove the form 20 because the base member 10 may be adhered to the concrete 22, which may lead to cracked or broken base plates 10.

Therefore, in view of the foregoing, there is a need in the art for an improved slip dowel system that facilitates placement of slip dowel rods within adjacent concrete slabs, while at the same time mitigating the deficiencies noted above.

### BRIEF SUMMARY

There is provided an improved concrete dowel placement apparatus having a base member configured to attach to the concrete form in a manner which mitigates several of the deficiencies noted above. More specifically, the base member includes a base plate that is disposable on the outer surface of the concrete form, and a base extension member that extends through an aperture located within the concrete form. In this regard, the base member is supported by the concrete form, and is therefore generally configured to withstand higher loads than the conventional prior art designs. Furthermore, the particular attachment configuration spaces the base plate from the concrete slab, which generally prevents the base member from becoming embedded within or adhered to the concrete. As such, removal of the form from the cured concrete tends to be much easier than removal of conventional prior art systems. In addition, the base member is less likely to crack or break during removal, which reduces the overall cost, as fewer base members may need to be replaced.

According to one embodiment, the concrete dowel placement apparatus is configured for use with a form member having a first face, an opposing second face, and an aperture extending from the first face to the second face. The concrete dowel placement apparatus includes a base member comprising a base plate defining a proximal face and an opposing distal face, and an extension member having a first extension member end portion and an opposing second extension member end portion. The first extension member end portion is coupled to the proximal face of the base plate. The base member is attachable to the form member with the extension member extending through the aperture and the proximal face of the base plate facing the first face of the form member. The concrete dowel placement apparatus further includes a dowel receiving sheath having a first sheath end portion and an opposing second sheath end portion and a hollow interior compartment extending longitudinally therein. The first sheath end portion is slidably extensible over the second extension member end portion such that the second extension member end portion resides within the interior compartment.

It is contemplated that the base member extension member may be sized to frictionally engage with the form upon insertion through the aperture. Such frictional forces may secure the base member to the concrete form. Alternatively, mechanical fasteners, such as a nail, may be used to secure the base member to the form.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an upper perspective view of a prior art concrete dowel placement apparatus including a base member and a dowel receiving sheath, wherein the base member is connected to the inner face of a concrete form;

FIG. 2 is a side sectional view of the prior art concrete dowel placement apparatus before concrete is poured;

FIG. 3 is a side sectional view of the prior art concrete dowel placement apparatus after the concrete has been poured;

FIG. 4 is an upper perspective view of one embodiment of a concrete dowel placement apparatus having a base member having an extension member extendible through an aperture formed within the concrete form and a base plate disposable adjacent the outer surface of the concrete form, and a dowel receiving sheath;

FIG. 5 is a side sectional view of the concrete dowel placement apparatus depicted in FIG. 4 before concrete has been poured;

FIG. 6 is a side sectional view of the concrete dowel placement apparatus depicted in FIG. 4 after concrete has been poured;

FIG. 7 is a side sectional view of the concrete dowel placement apparatus with the concrete form and base member removed from the concrete slab and the dowel receiving sheath; and

FIG. 8 is a side sectional view of two adjacent slabs of concrete with a dowel extending from one slab into the sheath disposed within the adjacent slab.

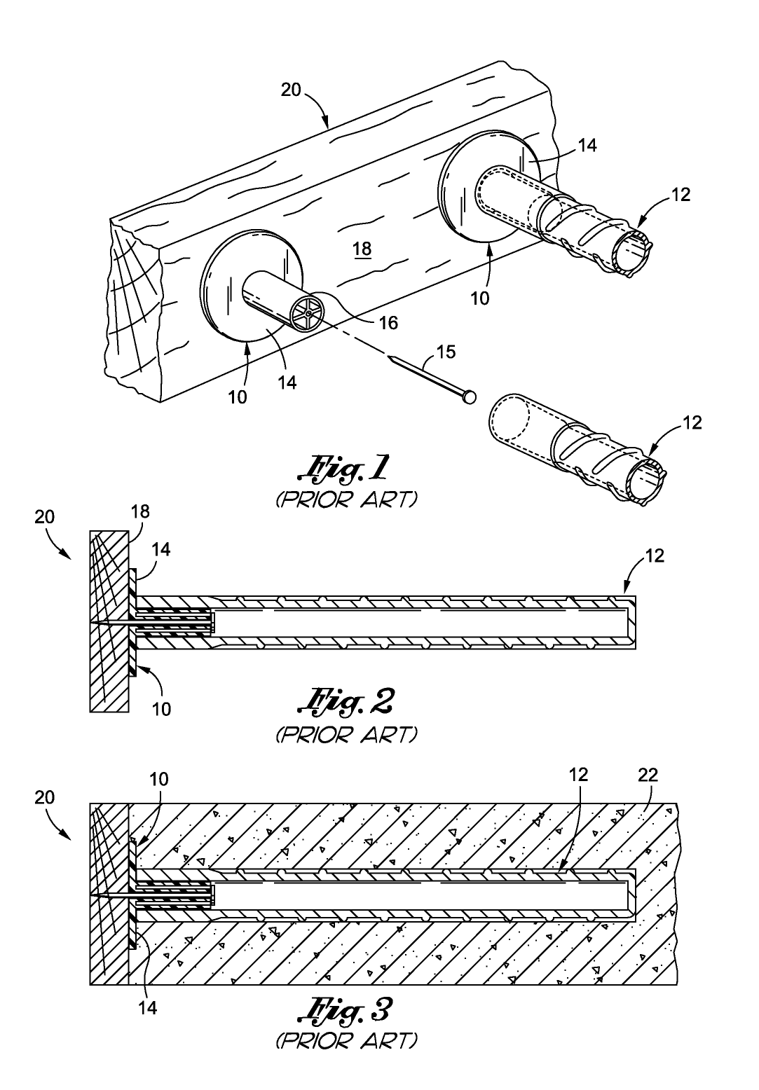

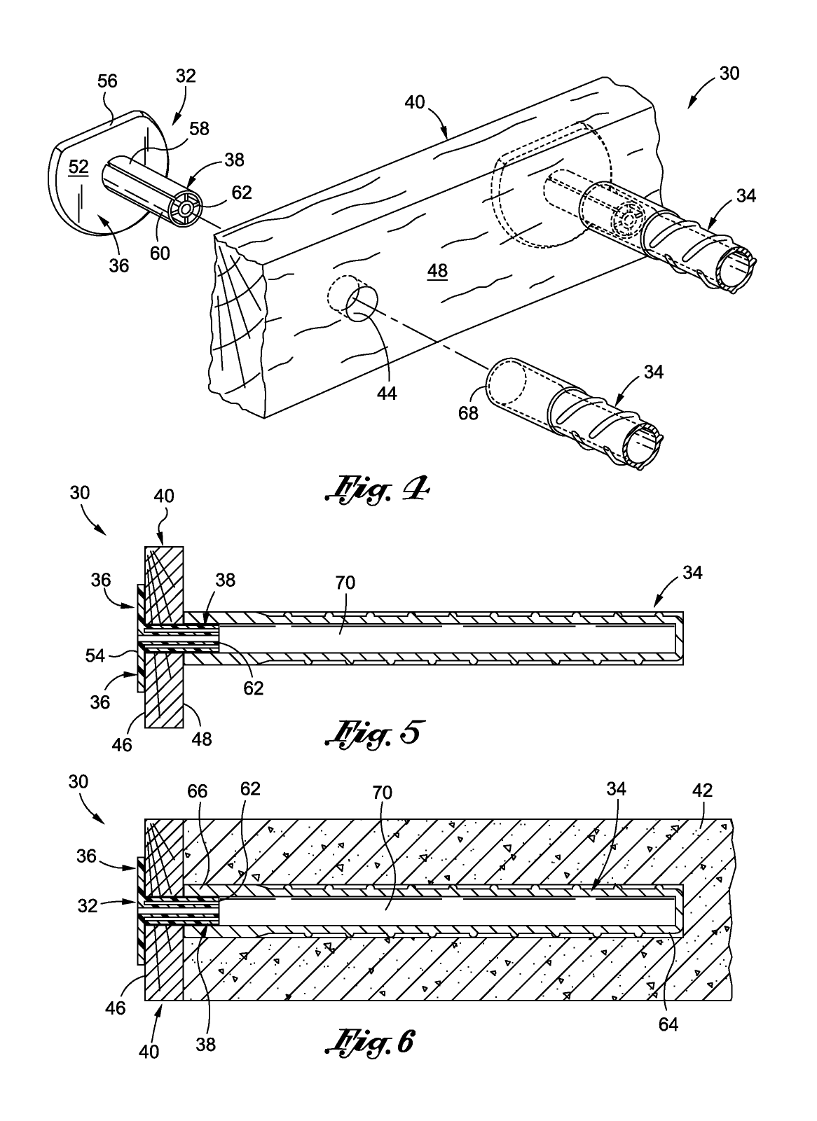

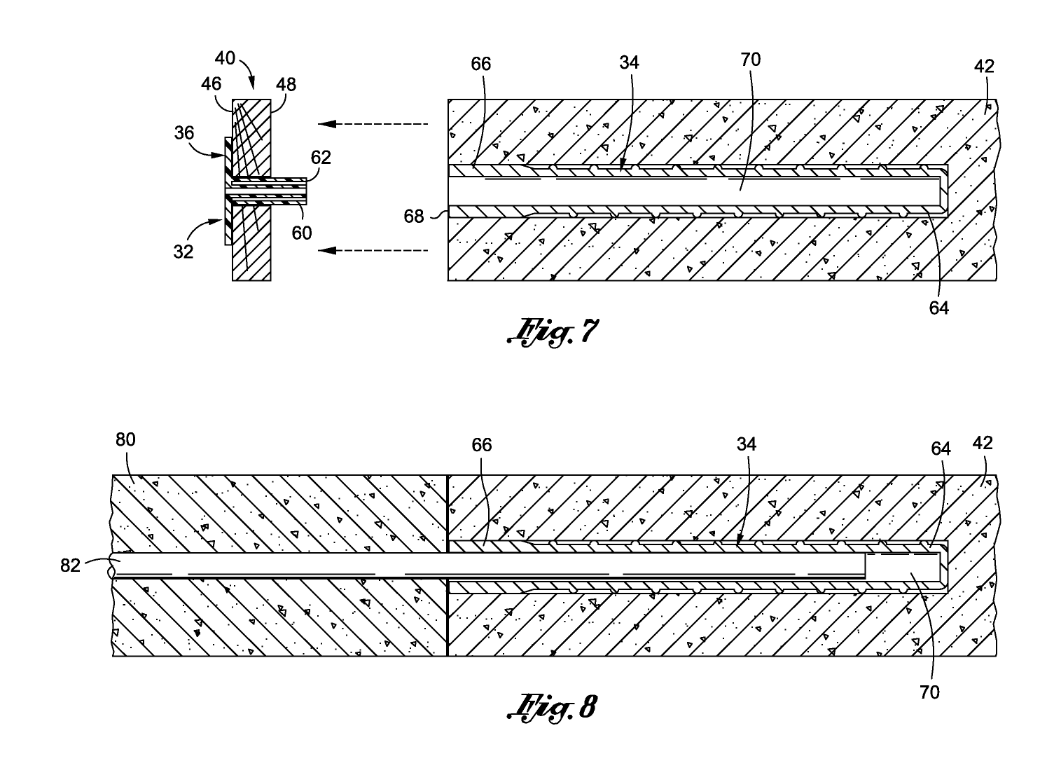

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. It is understood that the use of relational terms such as first and second, top and bottom, and the like are used solely to distinguish one from another entity without necessarily requiring or implying any actual such relationship or order between such entities.

Referring now to the drawings, wherein the showings are for purposes of illustrating preferred embodiments of the present invention only, and are not for purposes of limiting the same, there is shown a concrete dowel placement apparatus 30 including a base member 32 and an elongate, tubular dowel receiving sheath 34 which is engageable with the base member 32. The base member 32 includes a base plate 36 and an extension member 38 connected to and extending from the base plate 36. It is contemplated that the base member 32 is used with a concrete form 40 for forming poured concrete 42. Along these lines, the concrete form 40 includes one or more apertures 44 extending through the form 40, and defines a pour area where the concrete 42 is poured. The base member 32 is configured to engage with the form 40 such that the extension member 38 extends through an aperture 44 and the base plate 36 is disposed against the outer surface 46 of the form 40 (i.e, the surface outside of the pour area).

By positioning the base plate 36 outside of the pour area and the extension member 38 through the form 40, the base member 32 achieves several advantages relative to prior art dowel placement apparatuses. In particular, the connection between the base member 32 and the form 40 is enhanced by advancing the extension member 38 through the form 40. The nail used to fasten conventional base members to the form 40 may not always provide enough rigidity, which may lead to bending of the base plate 36 or complete fracturing of the base plate 36 if an excessive load is applied, as may occur if the base member 32 is stepped on or loaded with the weight of a rebar mat. Furthermore, due to the configuration and attachment of conventional base members to the inner surface 48 of the form 40, removal of the form 40 from the cured concrete 42 tends to be difficult. In particular, the base plate 36 tends to stick to the concrete 42, creating broken base plates 36, or a base plate 36 that remains with the concrete 42. Conversely, the base member 32 shown in the figures is attached to the form 40 such that the base plate 36 is spaced from the poured concrete 42. As such, the base plate 36 does not stick to the concrete 42 when the concrete 44 is removed. In this regard, according to one implementation, no portion of the base member 32 contacts the concrete 42 when the concrete 42 is poured. Furthermore, the strength of the base member 32 is enhanced by the engagement between the extension member 38 and the form 40. Therefore, breaking or bending of the base member 32 is mitigated in the event someone inadvertently steps on the base member 32, or if the base member 32 is loaded with a rebar mat.

The concrete form 40 may define a first face 46, an opposing second face 48 and an aperture 44 extending through the form 40 from the first face to the second face 48. The form 40 defines a form width “W” extending from the first face 46 to the second face 48. In this regard, the aperture 44 extends through the width W of the form 40. The form 40 may be fabricated from wood, plastic, or other materials known by those skilled in the art.

The form 40 defines a pour area into which the concrete 42 is poured and allowed to cure. In this regard, the concrete form 40 defines a boundary which corresponds to the shape of the desired concrete structure. After the concrete 42 is poured and cured, the form 40 is removed from the cured concrete 42.

The base member 32 is configured to be easily connected to the concrete form 40 in a manner which mitigates damage to base member 32 and also facilitates removal of the form 40 and base member 32 from the cured concrete slab. According to one aspect of the present invention, the unique attachment of the base member 32 to the concrete form 40 substantially isolates the base member 32 from the concrete 42 to reduce the likelihood of the base member 32 becoming partially implanted or embedded in the cured concrete 42.

The base member 32 includes a base plate 36 having a proximal face 52, an opposing distal face 54, and a sidewall 56 extending between the proximal face 52 and the distal face 54. The sidewall 56 may be angled such that the periphery of the proximal face 52 is circumscribed by the periphery of the distal face 54, with the sidewall 56 extending between the proximal face periphery to the distal face periphery. When the base member 32 is connected to the form 40, the proximal face 52 of the base plate 36 faces the first face 46 of the form 40, preferably in abutting relation with the first face 46. The sidewall 56 of the base plate 36 may be angled to provide a space between the base plate 36 and the form 40 to allow a user to grip the base member 32 to easily remove the base member 32 from the form 40.

The base member 32 additionally includes an extension member 38 coupled to the base plate 36. The extension member 38 includes a first end portion 58 and an opposing second end portion 60, with the first end portion 58 of the extension member 38 being connected to the proximal face 52 of the base plate 36 and the second end portion 60 terminating to define a distal tip 62. The extension member 38 defines an extension member length as the distance along the extension member 38 between the proximal face 52 of the base plate 36 to the distal tip 62.

According to one embodiment, the extension member 38 is integrally formed with the base plate 36 and is generally perpendicular to the base plate 36. However, it is understood that other embodiments may include an extension member 38 that is detachable from the base plate 36 to allow for replacement of the extension member 38, for instance, to replace the extension member 38 should the extension member 38 inadvertently break. The extension member 38 is coaxially disposed relative to the base plate 36, which extends radially from the extension member 38, although in other embodiments, the extension member 38 may be offset from the axis defined by the base plate 36. Furthermore, other embodiments may include an extension member 38 that is non-perpendicular to the base plate 36. In general, the angle between the base plate 36 and the extension member 38 corresponds to the angle between the axis defined by the form aperture 44 and the first and second faces 46, 48 of the form 40 to allow the extension member 38 to pass through the aperture 44 when the base plate 36 is disposed adjacent the first face 46 of the form 40.

The extension member 38 is preferably sized and configured to be complimentary to the size of the aperture 44 so as to effectuate frictional engagement between the extension member 38 and the form 40 when the extension member 38 is inserted into the aperture 44. In the particular embodiment shown in the figures, the extension member 38 defines a substantially cylindrical shape, and includes an outer sleeve and an inner sleeve with reinforcement walls extending between the outer sleeve and the inner sleeve. Although, those skilled in the art will appreciate that the extension member 38 may define other shapes and configurations without departing from the spirit and scope of the present invention.

The base member 32 is additionally configured to operative in cooperation with a sheath 34 defining an embedded end portion 64 and an opposing engagement end portion 66. The sheath 34 defines a shape that is generally complimentary to the shape of the extension member 38. In this regard, the sheath 34 shown in the figures is substantially cylindrical. The sheath 34 defines an engagement face 68 that abuts the second face 48 of the form 40, as explained in more detail below. An inner cavity 70 extends into the sheath 34 from the engagement face 68 toward the embedded end portion 64. The sheath 34 is further configured to slidably engage with the extension member 38. In this regard, the inner cavity 70 is configured to insertably receive the second end portion 60 of the extension member 38.

Although the foregoing describes a sheath 34 that is configured to slidably receive the extension member 38, it is contemplated that the slidable engagement between the sheath 34 and the extension member 38 may be achieved by creating an internal cavity within the extension member 38 sized to receive the sheath 34. In this regard, the sheath 34 would be insertable within the extension member 38 to achieve the slidable engagement between the extension member 38 and the sheath 34.

The outer surface of the sheath 34 may be textured to mitigate removal of the sheath 34 from the cured concrete. As shown in the figures, the outer surface of the sheath 34 includes threads to enhance the engagement of the sheath 34 within the concrete 42.

With the basic structural features of the apparatus 10 described above, the following discussion will focus on usage of the apparatus 10. The concrete form 40 is arranged to define the pour area where the concrete 42 is to be poured. The second, inner face 48 of the form 40 faces toward the pour area and the first, outer face 46 of the form 40 faces away from the pour area. The base member 32 is connected to the concrete form 40 by inserting the extension member 38 through the aperture 44 formed within the form 40 until the proximal face 52 of the base member 32 is brought into contact with the first, outer face 46 of the form 40. In this regard, the base plate 36 is disposed outside of the pour area, and a portion of the extension member 38 extends through the aperture 44 into the pour area. Preferably, the extension member 38 is sized to frictionally engage with the form 40 upon insertion through the aperture 44 so as to maintain the base member 32 in place relative to the form 40. It is also understood that mechanical fasteners, such as nails, may be used to secure the base member 32 to the form 40. For instance, nails may be inserted through the base plate 36 to connect the base plate 36 to the form 40.

The sheath 34 is then slidably engaged with the extension member 38 to properly position the sheath 34 within the pour area. In particular, the open, engagement end 66 of the sheath 34 is advanced over the distal tip 62 and second end portion 60 of the extension member 38 until the engagement face 68 is disposed adjacent the second face 48 of the form 40, preferably in contact therewith. The sheath 34 and extension member 38 are both configured to enable the sheath 34 to remain engaged with the extension member 38, with the sheath 34 suspended from the ground. Furthermore, when the sheath 34 is engaged with the extension member 38, the sheath 34 preferably covers the extension member 38, such that when the concrete 42 is poured into the pour area, the sheath shields the extension member 38 from the concrete 42.

With the sheath 34 engaged with the extension member 38, the concrete 42 is poured into the pour area. When the concrete 42 is poured, the sheath 34 becomes embedded in the concrete 42, while the base plate 36 and extension member 38 remain spaced from the concrete 42. Along these lines, the concrete form 40 and the sheath 34 collectively shield the base member 32 from the concrete 42.

The poured concrete 42 is given time to cure. After the concrete 42 cures, the base member 32 is removed from the form 40. Given that the base member 32 is shielded from the concrete 42, the base member 32 is easily removed from the form 40, i.e., the base member 32 is not partially embedded within or adhered to the cured concrete 42. Furthermore, the angled peripheral surface may provide a finger grip for pulling the base member 32 from the form 40. If mechanical fasteners are used to secure the base member 32 to the form 40, the mechanical fasteners are removed to facilitate removal of the base member 32 from the form 40. With the base member 32 removed, the form 40 is then removed from the cured concrete 42.

Although the foregoing describes the step of removing the base member 32 from the concrete form 40 prior to removing the concrete form 40 from the cured concrete 42, those skilled in the art will appreciate that the concrete form 40 may be removed from the concrete 42 before the base member 32 is removed from the concrete form 40.

The particular configuration of the base member 32 provides several advantages over conventional prior art devices. In particular, the configuration of the base member 32 which allows for the unique attachment of the base member 32 to the outer surface 46 of the concrete form 40 advantageously places the base member 32 away from the concrete 42. In this regard, the form 40 and the sheath 34 shield the base member 32 such that the base member 32 does not become stuck in the cured concrete 42. Consequently, the base member 32 may be easily removed without breaking after the concrete 42 is cured. As such, fewer base members 32 will break and the lifecycle of each base member 32 will increase, i.e., the base members 32 may be used for longer periods of time.

Furthermore, the configuration of the base member 32 may increase the amount of load that may be supported by the base member 32. When the base member 32 is engaged with the concrete form 40, the extension member 38 is advanced through the aperture 44 located within the form 40. As such, the concrete form 40 supports the extension member 38, and any load applied thereto. For instance, if a rebar mat is placed upon the extension member 38, the load of the rebar mat applied to the extension member 38 is supported by the concrete form 40. Furthermore, if a worker inadvertently steps on the extension member 38, the inadvertent load applied to the extension member 38 is supported by the form 40, which reduces the likelihood the extension member 38 would break.

Referring now specifically to FIG. 8, after the concrete slab has cured and the form 10 is removed, a second, adjacent concrete slab 80 is poured with a dowel 82 inserted within the sheath 34 and extending into the second adjacent concrete slab 80. After the second concrete slab 80 has cured, the dowel remains partially within the concrete slab 80 and partially within the sheath 34 to allow the slabs 80, 42 to move relative to each other, while at the same time remaining in the same plane.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A concrete dowel placement apparatus configured for use with a form member having a first face, an opposing second face, and an aperture extending from the first face to the second face, the concrete dowel placement apparatus comprising:
a base member comprising:
a base plate defining a proximal face and an opposing distal face; and
an axial extension member having a first extension end portion and an opposing second extension end portion, the first extension end portion being coupled to the proximal face;
the base member being attachable to the form member with the extension member extending through the aperture and the proximal face of the base plate facing the first face of the form member; and
a dowel receiving sheath having a first sheath end portion and an opposing second sheath end portion and a hollow interior compartment extending longitudinally therein;
the first sheath end portion being slidably extensible over the second extension end portion such that the second extension end portion resides within the interior compartment.

2. The dowel placement apparatus as recited in claim 1, wherein the extension member and the dowel receiving sheath define generally circular cross-sectional configurations.

3. The dowel placement apparatus as recited in claim 2, wherein the extension member is concentrically positioned within the dowel receiving sheath.

4. The dowel placement apparatus as recited in claim 1, wherein the base plate defines a rounded peripheral portion.

5. The dowel placement apparatus as recited in claim 1, wherein the extension member is sized to frictionally engage with the form member to mitigate removal of the extension member therefrom.

6. The dowel placement apparatus as recited in claim 1, wherein the interior compartment is sized and configured to be complimentary to the extension member.

7. The dowel placement apparatus as recited in claim 1, wherein the extension member includes an inner sleeve and an outer sleeve.

8. The dowel placement apparatus as recited in claim 7, wherein the extension member further includes at least one reinforcement wall extending between the inner sleeve and the outer sleeve.

9. The dowel placement apparatus as recited in claim 1, wherein the proximal face defines a planar surface.

10. A concrete dowel placement apparatus configured for use with a form member having a first face, an opposing second face, and an aperture extending from the first face to the second face, the concrete dowel placement apparatus comprising:
a base member comprising:
a base plate defining a proximal face and an opposing distal face; and
an extension member having a first extension end portion and an opposing second extension end portion, the first extension end portion being coupled to the proximal face;
the base member being attachable to the form member with the extension member extending through the aperture and the proximal face of the base plate facing the first face of the form member; and
a dowel receiving sheath having a first sheath end portion and an opposing second sheath end portion;
the first sheath end portion being slidably engageable with the second extension member end portion.

11. The dowel placement apparatus as recited in claim 10, wherein the extension member and the dowel receiving sheath define generally circular cross-sectional configurations.

12. The dowel placement apparatus as recited in claim 11, wherein the extension member is concentrically positioned within the dowel receiving sheath.

13. The dowel placement apparatus as recited in claim 10, wherein the base plate defines a rounded peripheral portion.

14. The dowel placement apparatus as recited in claim 10, wherein the extension member is sized to frictionally engage with the form member to mitigate removal of the extension member therefrom.

15. The dowel placement apparatus as recited in claim 10, wherein the extension member includes an inner sleeve and an outer sleeve.

16. The dowel placement apparatus as recited in claim 15, wherein the extension member further includes at least one reinforcement wall extending between the inner sleeve and the outer sleeve.

17. The dowel placement apparatus as recited in claim 10, wherein the proximal face defines a planar surface.

18. The dowel placement apparatus as recited in claim 10, wherein the extension member and the dowel are configured such that the second extension member end portion resides within the interior compartment.

19. A base member configured for dowel placement within a concrete slab, the base member being configured for use with a hollow dowel receiving sheath having a first sheath end portion and an opposing second sheath end portion and a form member having a first face, an opposing second face, and an aperture extending from the first face to the second face, the base member comprising:
a base plate defining a proximal face and an opposing distal face; and
an extension member having a first extension end portion and an opposing second extension end portion, the first extension end portion being coupled to the proximal face;
the base member being attachable to the form member with the extension member extending through the aperture and the proximal face of the base plate facing the first face of the form member;
the second extension end portion being slidably insertable into the first sheath end portion such that the second extension end portion resides within the dowel receiving sheath.

20. The dowel placement apparatus as recited in claim 19, wherein the extension member is sized to frictionally engage with the form member to mitigate removal of the extension member therefrom.
